(19) United States
(12) Patent Application Publication
(10) Pub. No.: US 2006/0032917 A1
(43) Pub. Date: Feb. 16, 2006

(54) Method for recycling identification codes

(75) Inventor: Rudolf Ritter, Zollikofen (CH)

Correspondence Address: PEARNE & GORDON LLP, 1801 EAST 9TH STREET, SUITE 1200, CLEVELAND, OH, 44114-3108, US

(73) Assignee: Swisscom Mobile AG, Bern (CH)

(21) Appl. No.: 11/203,891

(22) Filed: Aug. 15, 2005

(30) Foreign Application Priority Data
Aug. 16, 2004 (EP) EP04103932

(51) Int. Cl. G06Q 30/00; G05B 19/00; G08B 13/14

(52) U.S. Cl. 235/385; 340/5.92; 340/572.1

(57) ABSTRACT

Method for recycling one-time codes for individually marking individual products (11-15), the codes being each stored in a RFID tag (91-95) or encoded in the form of a bar code, including the following steps:
determining that a one-time code individually marking a product (11-15) that no longer needs to be traced is available, offering said code for individually marking another product. With this method, one-time codes can be recycled independently from their carriers such as for example RFID tags or bar codes and sold to buyers interested in new codes.

### REFERENCE DATA

This application claims priority of European patent application, filed on Aug. 16, 2004, the contents of which are hereby incorporated by reference.

### FIELD OF THE INVENTION

The present invention concerns a method for recycling identification codes. The present invention concerns in particular a method for recycling one-time codes serving for individually marking individual products.

### RELATED ART

Several systems for marking products are known. According to certain methods, for example, the product is marked with a so-called RFID element (or tag) that contains information about the product. Certain tags then have a memory area that can be read contactlessly with a RFID reading apparatus and in which the desired information can be stored. As the price of the tag depends on the size of the memory, such tags are used especially if only a small amount of information is required; for example, the product's production date, a series number, etc.

Methods are also known in which the desired information is retrieved from an external database in which several items of information (concerning the tags) are stored. In this case, a code located in the tag is read and used as a search criterion in the external database, from which the desired information is retrieved. The link between a product and the set of data in the database is static and permanent; a product marked with a tag always gives access to the same information.

In this case, the information content provided depends mostly only on the classification of the object (type of the product). However, methods are known in which all individual objects are marked with an individual one-time code in the RFID tag (for example with a series number). With this individual code, product-specific information for each particular product (for example the expiry date or the warranty period) is retrieved from an external database.

The EPC Global System has for example proposed RFID tags with EPC codes with which among others the distributed bar codes are to be replaced or complemented. EPC codes are numbers that contain a header and three sets of data. One set of data identifies a product manufacturer, a second set the exact type of the product and a third set is a series number that marks each particular product individually. EPC codes with 64 and 96 bits have been proposed; more could be possible.

EPC codes are stored in RFID tags. EPC-compatible RFID tags communicate contactlessly over a local radio interface and according to an open standard with RFID reader devices.

An EPC-capable RFID tag contains a single EPC code and each EPC code is associated with a single RFID tag. Each EPC RFID tag is thus unique; reading an EPC RFID tag allows the reader to retrieve an item of information that is different from the information that can be retrieved from another EPC RFID tag. Each product marked with an EPC code is thus associated with an individual, possible unique, item of information.

Although an EPC code reserves up to 36 bits for the series number (which means approx. 68 billion different numbers), this may not be sufficient, in particular for products that are produced in larger quantities than expected. In particular, a lack of certain codes may occur if the series of codes reserved for certain countries and/or producers were distributed awkwardly. New distributions and/or sub-distributions of certain code series must then be performed, or a new standard must even be developed that for example provides an increased memory space, which entails considerable excess costs.

One aim of the invention is thus to propose a method for avoiding a lack of one-time codes.

This aim is achieved with a method having the characteristics of the independent claim.

### BRIEF SUMMARY OF THE INVENTION

This aim is achieved in particular with a method for recycling one-time codes for individually marking individual products, the codes being each stored in a RFID tag or encoded in the form of a bar code; this method includes the following steps:
determining that a one-time code individually marking a product that no longer needs to be traced is available,
offering said code for individually marking another product.

With this method, one-time codes that mark a product that no longer needs to be traced can be used for marking new products. The codes are recycled independently from their carriers such as for example RFID tags or bar codes.

### BRIEF DESCRIPTION OF THE DRAWINGS

The invention will be better understood with the aid of the description of a preferred embodiment of the invention and with the aid of the figure, in which:

FIG. 1 shows a diagrammatic representation of the method according to an embodiment of the invention.

### DETAILED DESCRIPTION OF THE INVENTION

The inventive method will be described hereafter in connection with codes according to the EPC Global System, the codes being stored in RFID tags that are attached securely to the products to be identified. The inventive method can however also be used with other codes in RFID tags or with codes on other carriers (such as for example bar codes). The codes are however preferably unique and can thus serve for the univocal individual identification of individual items.

According to the EPC Global System, each code or each identification number contains for example three sets of data. One set of data identifies a product manufacturer, a second set gives the exact type of the product and a third set is a series number that marks each particular product individually.

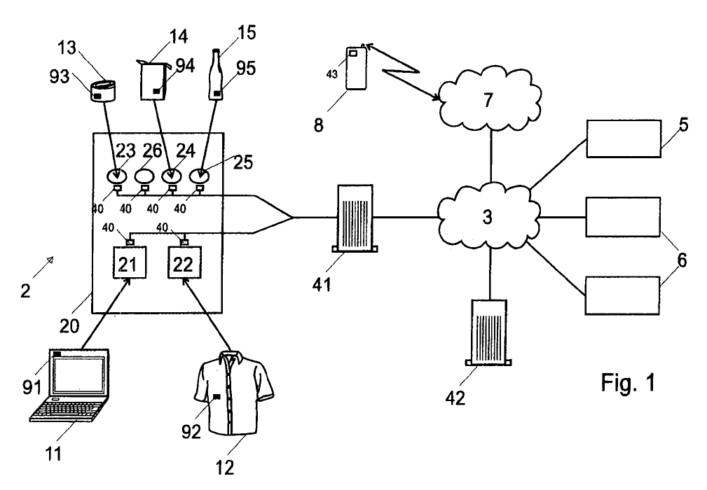

According to a preferred embodiment, represented diagrammatically in FIG. 1, the inventive method can be used preferably with products 11, 12, 13, 14, 15 of different types and possibly from different producers. Each individual product 11-15 is marked with a one-time code. The code is preferably stored in a RFID tag 91, 92, 93, 94, 9 that is attached to the corresponding product 11, 12, 13, 14, 15. The RFID tag 91-95 is preferably fastened firmly with the marked product 11-15 in order to prevent any substitution of the code. The RFID tag 91-95 can preferably no longer be separated from the product 11-15 without irremediably damaging and/or destroying the tag 91-95 and/or the product 11-15.

The RFID tags 91-95 each comprise an antenna and an integrated circuit with a memory area for storing the one-time code in digital form. The antenna and the integrated circuit are for example integrated in a self-adhesive label that is glued onto the product to be identified. Other types of RFID tags can however also be used within the frame of the invention. Certain RFID tags consist for example of a small plastic tab in which the antenna and the integrated circuit have been cast for example when the tab was mould. Yet other tags are integrated directly into the product itself during manufacture of the product, for example cast. For marking foods or drinks, the tag 93, 94, 95 is affixed for example in or on the packaging 13, 14, 15.

According to the present-day EPC standard, the one-time code serves mainly for individually marking the individual product 11-15 from its manufacture up to its final sale and thus allows the distribution process to be fully traced. Within the frame of the invention, however, the code can be used during the entire life of the product 11-15, for example to allow the monitoring and possibly the simplification of certain customer service processes such as repair and/or maintenance processes.

The code is read at certain points in time and possibly at different locations by means of RFID readers, for example when the product 11-15 leaves its place of production, when it is sold, etc. According to the EPC standard, all RFID readers 40 are preferably connected to one or several so-called Savant computers 41 that connect with an ONS (Object Name Service) server 42 over a telecommunication network 3 (for example over a local network or over the Internet). The Savant computer 41 has the possibility of sending a request with a certain EPC code (e.g. read by the reader 40) to the ONS sever 42 in order to receive the address of one or several PML (Physical Markup Language) pages that contain static and/or dynamic data about the corresponding product 11-15 and that are stored on one or several computers connected with the network 3. Static data include for example the type of product, the user's manual, etc. Dynamic data include for example the current location of the product 11-15, the current storage temperature, etc. The Savant computer 41 can preferably also add new information onto the PML page and/or update the existing information.

With this system, certain processes of distribution, storage and/or retail sale can be simplified and/or better monitored.

Other systems for individually tracing individual products are however also possible within the frame of the invention. However, when the RFID tag or the bar code of an individual product is read, only the one-time code is preferably read whilst the other static and dynamic data about the corresponding product are stored in one or several databases and are accessible with the aid of the code.

The marked products 11-15 include for example:
different types of electronic devices 11 that require a univocal individual identification for a more efficient distribution and for example for checking the warranty;
different foods or drinks 13, 14, 15 that require a full traceability for a better quality control;
clothing 12.

The above mentioned products are given only by way of illustrative example. In the frame of the invention, the products 11-15 can include any kind of products that for whatever reason require an individual marking.

Each RFID tag 91-95 preferably includes a memory area that can be written only once. This memory area is for example a ROM (Read-Only Memory). The corresponding code is preferably stored in this memory area so that it can no longer be deleted and/or altered. Certain tags however possibly include a further memory area, for example a PROM (programmable ROM), an EEPROM (electrically erasable PROM), etc., in which other (possibly temporary) data can be stored and deleted again.

According to an embodiment of the invention, if the product 11-15 is for example not in operation, has been used or is simply no longer used, the product 11-15 or only part thereof on which the tag 91-95 is attached is brought to a collection point 2. In the case of certain foods or drinks 13, 14, 15, for example, only the packaging (onto which the tag 93, 94, 95 has been glued) is brought to the collection point 2.

The collection point 2 includes for example a container 20 in public facilities, in a store, with an official agency etc. Preferably, different types of products 11-15 can be disposed of in a single or in several containers 20 at the collection point 2. In the frame of the invention, certain collection points can accept only certain products (for example products from a certain producer, of a certain type, etc.), while other collection points accept all products that are marked with a certain type of tag and/or code. Certain collection points are for example managed by independent structures or by the producers themselves.

At the collection point 2, the code of the product 11-15 to be disposed of is read, for example in that the RFID tag 91-95 of the product is read preferably automatically with a RFID reader 40.

The collection point 2 includes for example a container 20 with different openings 21-26 for different products. One or several RFID readers 40 are for example arranged next to the openings 21-26 that automatically read the RFID tag 91-95 of the product 11-15 when the product 11-15 is disposed of through the corresponding opening 21-26 in the container.

According to a further embodiment, the collection point 2 includes a container 20 with one or several openings 21-26 that open only if a valid code is read. At the collection point 2, one or several RFID readers 40 are for example placed on the container 20. If a product 11-15 is brought to the collection point 2, the RFID tag 91-95 of the product 11-15 to be disposed of is read by one of these readers 40. If the read code for example fulfills certain criteria, the container 20 is opened. If the container 20 has several openings 21-26, only the opening designed for the product to be disposed of is opened. After the product has been thrown into the container 20 and/or after a certain time, the container 20 closes again.

After the product 11-15 has been thrown into the container 20, its RFID tag 91-95 is preferably read once again in the container 20 (for example through a further RFID reader, not represented), in order to check that the product 11-15 or at least its RFID tag 91-95 is indeed in the container 20. Other control methods (for example by video monitoring, weighing of the contents of the container 20, etc.) are however also possible within the frame of the invention.

In a further embodiment, the collection point 2 is operated completely or at least partially manually. The product 11-15 to be disposed of is for example given to a person that reads the RFID tag 91-95 with a RFID reader. The product 11-15 is then disposed of manually (for example by that person) in a container or on a shelf.

The types of collection points 2 described above are given by way of example. Further embodiments of collection points are also possible within the frame of the invention. According to the inventive method, collection points of different types can be used together.

In yet another embodiment, the RFID tag 91-95 of the product 11-15 to be disposed of is read by the RFID reader 43 of a mobile device 8. The mobile device 8 is for example a mobile telephone, a PDA etc. that has a RFID reader 43 and preferably an interface to a telecommunication network 7. According to this embodiment of the method, the code of the product 11-15 that is for example no longer used or that has been used is read by the last user or owner of the product for example with his mobile device 8. The product 11-15 is then either brought to a collection point 2, where the actual disposal of the product is possibly checked (for example by reading again the RFID tag 91-95), or simply thrown into a waste bin. With the read code, a message is then sent by the mobile device 8 to the tracing system over the telecommunication network 7 in order to inform it that the corresponding product 11-15 is no longer used and was possibly disposed of and/or destroyed. According to this embodiment, a deposit is refunded to the user for the recycling of the code and/or of the product 11-15, for example by crediting it on his telephone bill or on a prepaid card. In a similar manner, the costs for the recycling or disposal of the product 11-15 can also be billed to him.

After the code has been read in the collection point 2 and/or with the aid of the mobile device 8, the corresponding product 11-15 is registered in the corresponding tracing system as being no longer traced. It is thus determined in the data processing systems for tracing the corresponding product 11-15 on the basis of the data from the code reader, which can be for example a RFID reader or a bar code reader depending on the code carrier, that the read code is again available.

In a system according to the EPC standard, for example, a ONS request is sent to an ONS server 42 with the read code in order to ascertain the address of the PML page (or pages that contain the data about the product 11-15). In an embodiment of the invention, the information that the corresponding product 11-15 is no longer traced by the system is recorded on at least one PML page. In another embodiment, this information is recorded on a new PML page. The PML pages pertaining to the product 11-15 are for example immediately archived and maybe deleted after a certain time.

The producer 5 of the product 11-15 is preferably for example immediately informed through the modification of the PML page or through a data message that the product 11-15 is no longer traced in the tracing system and the corresponding one-time code is available again. The newly available code is preferably offered to the producer 5 of the product 11-15 previously individually marked with this code for marking a new individual product.

If the collection point 2 is managed by a structure independent from the producer, the new available code is for example sold to the producer 5. In an embodiment, the recycling of the corresponding product 11-15 is furthermore billed to the producer 5 on the basis of the read code.

The RFID tag 91-95 that marks the product 11-15 that is no longer to be traced and which is preferably attached to it, is preferably destroyed after having been read and/or it is recorded in the RFID tag that the corresponding code has been recycled so that the reader at the next reading of the RFID tag 91-95 is immediately informed that the RFID tag is no longer valid.

In order to avoid data conflicts in the tracing system between two successive products with the same one-time code, the newly available one-time code in one embodiment of the invention is released for marking a new individual product only after a certain time and/or after the final destruction of the RFID tag (or bar code) marked with this code.

In case the producer 5 is not interested in recycling the newly available code, he then has the possibility of commercializing it, for example by offering it individually or in groups of several successive codes directly to an interested buyer 6 that can then mark with it his own products, or by having them auctioned (for example through external structures). The buyers 6 of the newly available one-time codes are for example producers that will then use them to identify their new products because they for example no longer had enough codes to cover their short to long term planned production.

Within the frame of the invention, several methods for commercializing the newly available codes can be used.

In an embodiment of the invention, the newly available codes are for example offered to different buyers 6 on the basis of a priority system. The codes are first offered to a first buyer. If the latter rejects the offer, they are offered to a second buyer, etc. The priority can be set for example on the basis of the acquisition date and/or on the basis of other criteria.

In another embodiment, auctions are for example regularly held where newly available codes are sold. These auctions take place for example in a certain location, simultaneously in different locations and/or over the Internet.

In yet another embodiment, there is an exchange market for newly available codes. Producers 5 (or their representatives) that no longer wish to use certain codes offer them for a certain starting price at this exchange market, where potential buyers 6 can acquire them. The exchange market is for example an electronic exchange operated over a data network 3 (such as e.g. the Internet). The buyers 6 have for example subscribed a free or paying service to gain access to the exchange market and/or to receive an alert when codes that could interest them (for example on the basis of criteria previously indicated by the interested party) are offered.

A combination of these different methods described above for commercializing the newly available codes is also possible within the frame of the invention.

In an embodiment of the invention, the newly available one-time codes that are no used by the corresponding producer 5 are simply set aside until they are used again or they are for example returned to the issuing institution.

In the above embodiment of the invention, the code of the product 11-15 that is for example no longer used and/or that has been used is read before disposal of the product 11-15 and then recycled. In another embodiment of the invention, the producer 5 decides that certain one-time codes that have been used for individually marking his products can be re-used again after a certain time without a message confirming the destruction or use of the product 11-15 being necessary. The fact that the corresponding codes are again available is thus determined in the data processing systems for tracing the products on the basis of a time span for example counted from the production of the corresponding product. This embodiment of the invention is for example used for marking foods or drinks 13, 14, 15 that are with a high probability no longer on the market after a certain time.

With the method of the invention, at least part of the no longer used one-time codes are recycled. The codes are recycled independently from their carriers, i.e. from the RFID tag 91-95 or from the bar code.

1. Method for recycling one-time codes for individually marking individual products, the codes being each stored in a RFID tag or encoded in the form of a bar code, including the following steps:
determining in a data processing system on the basis of data from a code reader and/or on the basis of a time span that a one-time code individually marking a product that no longer needs to be traced is available again,
offering said newly available code for individually marking another product.

2. Method according to the preceding claim, said step of determining including the reading of said newly available code from a RFID tag or from a bar code.

3. Method according to claim 1, with the following additional step:
destroying said RFID tag or said bar code.

4. Method according to claim 3, with the following additional step:
recording in said RFID tag the recycling of said newly available code.

5. Method according to claim 4, said reading being performed at a collection point for recycling said product or a part of said product.

6. Method according to claim 5, said reading being performed with a mobile device having a RFID reader or a bar code reader and an interface to a telecommunication network.

7. Method according to claim 1, said step of determining being decided after a certain time after production, distribution and/or end sale of said product.

8. Method according to claim 1, a deposit refund for the recycling of said code and/or of said product being credited to a user.

9. Method according to claim 1, costs for recycling said product being billed to a user or to a producer of said product.

10. Method according to claim 1, said newly available code including a data set for identifying a producer of said product.

11. Method according to claim 1, said newly available code being first offered to said producer.

12. Method according to claim 1, said newly available code being offered by said producer to another buyer.

13. Method according to claim 1, said newly available code being sold.

14. Method according to claim 1, said newly available code being sold at an auction.

15. Method according to claim 1, said newly available code being sold electronically.

16. Method according to claim 1, said newly available code being via Internet.

17. Method according to claim 1, said newly available code being offered together with other codes that have a common data set with said newly available code.

18. Method according to claim 1, with the following additional step:
archiving data about said product in a tracing system.

19. Method according to claim 18, with the following additional step:
recording the recycling of said code in said data.

20. Method according to claim 1, said newly available code being an EPC code.

21. Method according to claim 20, with the following additional step:
modifying in an ONS server the correlation of at least one PML page allocated to said newly available code.

22. Method according to claim 20 or 21, with the following additional step:
modifying a PML page containing data over said product that is no longer to be traced.

23. Method according to one of the claims 20 to 22, with the following additional step:
allocating in an ONS server a new PML page with said newly available code.
